(19) United States
(12) Patent Application Publication
(10) Pub. No.: US 2005/0191117 A1
(43) Pub. Date: Sep. 1, 2005

(54) Connection device

(76) Inventor: Armin Herb, Apfeldorf (DE)

Correspondence Address: DAVID TOREN, ESQ.;ABELMAN FRAYNE & SCHWAB, 666 THIRD AVENUE, NEW YORK, NY, 10017-5621, US

(21) Appl. No.: 11/054,162

(22) Filed: Feb. 9, 2005

(30) Foreign Application Priority Data
Feb. 9, 2004 (DE) 10 2004 006 206.4

(51) Int. Cl. F16B 7/06

(52) U.S. Cl. 403/43

(57) ABSTRACT

A connection device (11) for anchoring means (5, 6, 7) of a section (3) suspended on a supporting structure comprises a central element (12) and two pivotal swivel elements (21) that can be connected to the central element (12). The central element (12) has two counter coupling means (13) configured as passageway means for forming passage (14) with two end surfaces. The swivel elements (21) each have a coupling means (25) that is insertable into the counter coupling means (13) configured as an insertion part (32) having a gripper part (27) for gripping one of the end surfaces of the passage means (14). The central element (12) is provided with a receiving part (18) for a first anchoring means (5) and the swivel elements (21) are each provided with a receiving part (28) for a second anchoring means (6 or 7).

### BACKGROUND OF THE INVENTION

1. Field of the Invention

The invention is directed to a connection device for anchoring means for a section suspended from a supporting structure having a central element and at least one pivotal swivel element that can be arranged on the central element. The connection device has at least one counter coupling means and at least one coupling means that can be introduced into the counter coupling means for the creation of the pivotal connection between the central element and the at least one swivel element. The central element has a receiving part for a first anchoring means and the at least one swivel element has a receiving part for a second anchoring means. Furthermore, the invention is directed to a central element and a swivel element, in particular for this type of connection device.

2. Description of the Prior Art

Industry requires in its production operations a high degree of flexibility in the utilization of appropriate buildings such as steel and reinforced steel buildings. To withstand today's competition, conversion of the production lines is frequently necessary within short periods. This requires versatile attachment means for the required, often extensive utilities and processing media such as power, compressed air and water.

In order to assure a number of connections to utilities and processing media, for instance, an intermediate section (hereinafter called “section”), made of standardized section supports, mounting rails or the like, are provided in the form of a gridwork ceiling under the roof of the building, on which the conduits for utilities and processing media are arranged. These sections can be equipped as defined by the user and have breaks and even superstructures. The connection of the section to the desired machine location within the building is done using the corresponding supply lines from above.

Large inside heights, wide support intervals and low load carrying at the roof/ceiling covering result in excessively costly and expensive solutions for affixing the sections to the vertical supports bearing the building roof, whereby these solutions frequently cannot be re-used at the time of converting the production operation in the building.

For a wide area fastening means for a grid ceiling serving as a section, the ceiling, for instance, by means of anchoring means in the supporting structure of the building, at the roof supports of a steel or reinforced concrete building, can be suspended at a specific distance from the latter, whereby the distance can be several meters. Due to the large support intervals, the suspension construction for the suspended section must run perpendicularly and diagonally from the supports to the grid of the suspended section. The diagonal suspensions must be run together using the suspended section. In addition, mounting of the suspended sections is done frequently at a great height over the floor of the building, so that the connection devices used must be easy to handle in order to reduce the cost of mounting and the risk of accident for personnel doing the mounting.

DE 32 24 986 A1 discloses a suspension construction, wherein concrete anchors are cast in a ceiling in a predetermined grid and are used as the connection for vertical anchoring means configured as threaded rods for a suspended section. The vertically oriented threaded rods are stayed in order to provide earthquake safety and receiving any horizontal forces that may occur in the suspended section. The connection device for connecting the vertical with the diagonal threaded rods comprises a screw-on connector part that can be screwed onto the vertical threaded rod, in which a joint part mounted rotationally movable is arranged therein. The connecting part has a receptacle for a pin of the articulation part. In addition, the articulation part has a receiving part for the diagonal threaded rod. The threaded bolt is passed through the receptacle and by means of a nut secured on the articulation part or the receptacle is provided with an inner thread, in which the threaded bolt can be engaged.

The drawback in the known solution is the fact that the connection device is suitable only for joining of two anchoring means and is expensive to install. In addition, location of the securing elements is limitedly possible using the known solution.

The lines of action of the forces acting on the anchoring means are effectively off set relative to each other in this connection device, so that the connection device is subject to additional transverse and torque loads and therefore must be configured massively.

### SUMMARY OF THE INVENTION

The object of the invention is to provide a connection device that can sustain high loads and that is interchangeably flexible with regard to the angular position of the anchoring means.

The object of the invention is achieved by the features of the claims.

According to the invention, the at least one counter coupling means comprises a passage means having end surfaces and the at least one coupling means has an insertion part that can be inserted into a passage of the passage means together with a gripper part for gripping around one of the end surfaces of the passage.

The central element and the at least one swivel element can in a first assembly step be affixed to the corresponding anchoring means and then joined to the connection device using the coupling means and the counter coupling means. In a variation hereof, the central element and the at least one swivel element are first joined using the coupling means and the counter coupling means and the anchoring means then affixed to the corresponding receiving part. By means of the gripper part, the connection perpendicular to the section, which is tensioned by the anchoring means, is assured. The forces occurring in the anchoring means all lie in one plane, so that the connection device does not have to absorb any shear or torque forces and, can take on high forces even in a simple configuration. By means of the pivotal connection between the central element and the at least one swivel element, any number of angular positions of the anchoring means relative to each other can be arranged on one and the same connection device.

Preferably the at least one counter coupling means comprises a circular-cylindrical passage and the at least one coupling means is configured as a bolt as an insertion part, which is configured preferably circular cylindrical and complementary to the passage. The passage and the insertion part form, in the assembled state of the connection device according to the invention, a bearing, whereby the passage forms the bearing eyelet and can have a coating or a bearing element such as a ball bearing. The passage has a groove running diagonally to the section spanned by the cross-section of the section. The gripper part is configured at a free edge of the bolt. Preferably the gripper part is formed substantially complementary to the groove. Along with a bolt, the insertion part comprises also a pin or the like, which is configured as a solid body or a hollow body.

Accordingly the central element and the at least one swivel element can be brought together into a specific position of the at least two parts of the connection device, which normally in the fixed position at the anchoring means of the at least two parts of the connection device are not occupied relative to each other. Accordingly, even with a loading on the connection device perpendicular to the section, which is clamped by the anchoring means, an unintentional loosening of the connection between the central element and the at least one swivel element in the assembled state of the connection device is prevented.

In a variation thereof, the insertion part of the coupling means is a slotted sleeve with a widened edge arranged at the free end of the sleeve, which is used as a gripper part for gripping one of the front edges of the counter coupling means configured as a passage. When joining the at least two parts of the connection device, a snap-in connection between the coupling means and the counter coupling means is created.

Preferably, at least one of the end surface regions of the passage has a depression, which is optimally configured to be circumferential and whose extensions lying in the section spanned by the passage are greater than the corresponding extensions of the passage. If the passage is configured as a cylindrical hole, the depression is preferably arranged concentric to same and the limitation of the depression has a radius that is larger than the radius of the passage. The depression is preferably configured so the gripper part and the insertion part do not protrude over the section spanned by the outside surface of the corresponding element. By virtue of the circumferentially arranged depression, there is available essentially a pivot range of the at least one swivel element arranged on the central element of 360°.

Advantageously, at least in one area of the counter coupling means at least one stop is provided for limiting the swivel range of the at least one, swivel element, that is pivotal with the swivel element and that is connectable to the central element. Because the connection device according to the invention must frequently be assembled at great height over the building floor, the occupational safety of the fitting personnel must be carefully considered. If at least one swivel element is joined with the central element, the at least one stop prevents an undesirable rotation away of the swivel element on the central element in the insertion position, in which the swivel element can fall out of the central movement during assembly. After the joining process the installer has his hands free for the other installation work. By means of two or more stops in one region of the counter coupling means, the allowable swivel range for a swivel element connected to the central element is limited in such a fashion that statically undesirable orientations of the at least two parts of the connection device relative to each other are made impossible.

Preferably two counter coupling means are provided for an arrangement of two coupling means. Using this connection device according to the invention, two anchoring means coming diagonally from the supports of the supporting structure can be joined with an anchoring means that is vertically oriented and connected to the suspended section.

In a preferred embodiment of the connection device according to the invention, the at least one counter coupling means is provided on the central element and the coupling means on the at least one swivel element. If the central element has two counter coupling means, then the depressions in at least one of the end surface regions of the passage preferably each opposingly arranged on the lateral walls of the central element, so that the one swivel element can be led in from the one side and the other swivel element can be led in from the other side. In this fashion, a secure connection of the parts of the connection device with each other is assured under different loads on the connection device. The positions of the groove in the passages of the central element and the orientation of the gripper part on the insertion part of the swivel elements are preferably selected, so that in the insertion position of the two swivel elements would mutually hinder each other and accordingly an orientation of swivel elements into the insertion position would not be practicable.

In a further preferred embodiment of the connection device according to the invention, the at least one coupling means is provided on the central element and the counter coupling means is provided on the at least one swivel element. If the central element has two coupling means, then the insertion parts with the gripper parts are preferably arranged each opposingly on the lateral walls of the central element, so that the one swivel element is led in from the one side and the other swivel element is led in from the other side. In this fashion, a secure connection of the parts of the connection device with each other is assured under different loads on the connection device. The positions of the groove in the passages of the central element and the orientation of the gripper part on the insertion part of the central element are preferably selected, so that in the insertion position of the two swivel elements they would mutually hinder each other and accordingly an orientation of swivel elements into the insertion position would not be practicable.

Preferably, the receiving part of the central element has a threaded segment for fixation of the first anchoring means to the central element. The threaded segment is matched to the connection region on the first anchoring means. If this connection region, for example, has a threaded segment with an external thread, then the threaded segment on the central element is configured as an internal thread, which can be brought into engagement with the external thread of the connection region. If, on the other hand, this connection region has a threaded segment with an internal thread, then accordingly the threaded section on the central element is configured as an external thread that can be brought into engagement with the internal thread. In a variation hereof the receiving part of the central element is provided with a frictional fit device, wherein the connection region of the anchoring means can be inserted.

Advantageously, the at least one swivel element has a first member, a second member and the two members are connected by a connection segment, wherein the coupling means or the counter coupling means is configured on the first member of the swivel element and the receiving part for the anchoring means is configured on the second member of the swivel element. By means of this arrangement of the at least one swivel element, the lines of action in the assembled condition of the individual parts of the connection device can be brought from the anchoring elements to a common point of all lines of action. The distance between the first member and the second member of the at least one swivel element is selected so that sufficient space for accommodation of the anchoring means and the connection device is available.

Preferably, the receiving part for the anchoring means is configured on the second member of the swivel element as an open slot running from one side of the second member. Accordingly, a connection region of the anchoring means can be inserted into the receiving part and affixed to the at least one swivel element. The effort expended in assembly is thus substantially reduced.

Preferably, the connection segment of the swivel element as an insertion opening for inserting the anchoring means, wherein advantageously the insertion opening is in communication with the slot in the second member of the swivel element. Accordingly, a connection region of the anchoring means that is substantially larger than the anchoring means, as is required in the case of anchoring means for high loads, can also be inserted into the receiving part and affixed to the at least one swivel element. For partially large connection areas of the anchoring means, the insertion opening can be in part expanded. Accordingly, the effort expending at assembly is reduced also in the case of connection devices for high loads.

The anchoring means are threaded rods, which can sustain a limited degree of compression loads along with traction loads. In lieu of threaded rods, smooth round rods, reinforcement rods or cables made of steel can be used as anchoring means. The anchoring means have a fixation assembly in a connection region. If, the anchoring means are configured as threaded rods, smooth round rods or reinforcement rods, their connection region, has as a fixation means a threaded segment with an external thread and nuts arranged thereon. Preferably, the fixation means comprises two nuts on the anchoring means for fixation of the anchoring means to the swivel element, which clamp the second member of the swivel element with the receiving part between them. In the case of cables being used as anchoring means, similarly their connection region also has a threaded section with an outside thread and nuts that can be arranged thereon. Using the fixation means, the anchoring means in the assembled condition of the individual parts of the connection device can be easily outfitted and affixed, which simplifies the assembly effort.

A central element according to the invention, in particular for the aforementioned connection device, has at least one counter coupling means for an arrangement at least of one swivel element having one coupling means and a receiving part for a first anchoring means. The at least one counter coupling means comprises a passage having two end surfaces, the passage preferably being configured as a circular cylindrical bore hole. For the purpose of securing a connection between the central element and a swivel element connectable thereto, the at least one passage in the central element advantageously has a groove, which runs diagonally to the plane spanning the cross-section of the passage, in which an insertion part of a coupling means of a swivel element having a gripper part is inserted and which can be locked by twisting.

The central element is fixed in a first assembly stem to the corresponding anchoring element. Preferably, the receiving part of the central element has a threaded segment for fixing the first anchoring means to the central element. The threaded segment is matched to the connection region on the first anchoring means. If this connection region, for example, has a threaded segment with an external thread, then the threaded segment on the central element is configured as an internal thread, which can be brought into engagement with the external thread of the connection region. In a variation hereof the receiving part of the central element is provided with a frictional fit device, wherein the connection region of the anchoring means can be inserted.

Preferably, at least one of the end surface regions of the passage has a depression, which is optimally configured to be circumferential and whose extensions lying in the section spanned by the passage are greater than the corresponding extensions of the passage. If the passage is formed as a cylindrical hole, the depression is preferably arranged concentric to the and the delimitation of the depression has a radius that is larger than the radius of the passage. The depression is preferably shaped in such a fashion that a coupling means such as a bolt with a gripper part does not protrude beyond the section spanned by the external surface of the central element. By virtue of a peripherally arranged depression, essentially a swivel range of 360° is available to a swivel element arranged with the central element.

Preferably, at least in a region of the counter coupling means, at least one stop is provided for limiting the swivel range of the swivel element located on the central element. If at least one swivel element is joined with the central element, the at least one stop prevents an undesirable rotation away of the swivel element on the central element in the insertion position, in which the swivel element can fall out of the central element during assembly. By means of two or more stops in one region of the counter coupling means on the central element, the allowable swivel range for a swivel element connected to the central element is limited in such a fashion that statically undesirable orientations of the at least two parts of the connection device relative to each other are made impossible.

A central element according to the invention, in particular for the aforementioned connection device, has at least one coupling means for an arrangement at least of one swivel element having one counter coupling means and a receiving part for a first anchoring means. The at least one coupling means comprises an insertion part that can be inserted into a passage, the insertion part having a gripper part for gripping a facial edge of a passage. For securing a connection between the central element and a swivel element that can be connected thereto, the latter is led via the coupling means at the central element and the swivel element is locked with the central element by twisting about the coupling means.

Preferably, the at least one coupling means of the central element comprises a bolt as the insertion part, the bolt preferably having a circular cylindrical configuration. The gripper part is configured at a free edge of the bolt. Along with a bolt, the insertion part comprises also a pin, sleeves or the like, which are configured as a solid bodies or hollow bodies.

Advantageously, two counter coupling means or two coupling means are provided on the central element for a pivotal arrangement of two swivel elements. Using this central element according to the invention, two anchoring means coming diagonally from the supports of the supporting structure can be joined with another anchoring means that is vertically oriented and connected to the suspended section. Preferably, both counter coupling means or the two coupling means on the central element for providing a secure connection between the central element according to the invention and the swivel elements that can be arranged thereon are arranged opposing each other on the sides of the central element, so that a swivel element from the one side and a second swivel element from the other side must be provided.

A swivel element according to the invention for an aforementioned connection device has a coupling means for providing a pivotal connection between a connecting element such as a central element and the swivel element and a receiving part for a second anchoring means. The coupling means comprises an insertion means having a gripper part for gripping an end surface of a passage.

The insertion part of the coupling means on the swivel element is preferably a bolt, the bolt having preferably a circular cylindrical configuration. The bolt has a gripper part for securing the connection between a connecting element such as a central element and the swivel element. Accordingly, a central element and the swivel element can be brought together in a specific position of the at least two parts of the connection device. Accordingly, in the case of a load perpendicular to the section, which is anchored by the anchoring means, an unintentional release of the connection between a central element and the swivel element is prevented.

In a variation thereof, the coupling means of the swivel element is provided as a slotted sleeve having a widened edge arranged at the free end of the sleeve, which serves as a gripper part. When joining the at least two parts of the connection device, a snap-in connection between the coupling means and the counter coupling means is created.

A swivel element according to the invention, in particular for the aforementioned connection device, has at least one counter coupling means for an arrangement at least of one swivel element having one coupling means and a receiving part for a second anchoring means. The at least one counter coupling means comprises a passage having two end surfaces, preferably being configured as a circular cylindrical bore hole.

For the purpose of securing the connection between the swivel element and a central element having the coupling means, the passage in the swivel element advantageously has a groove running diagonally to the region spanned by the cross-section of the passage, wherein an insertion part of a coupling means having a gripper part is guided and can be locked by a twisting action.

Preferably, at least one of the end surface regions of the passage has a depression, which is optimally configured to be circumferential and whose extensions lying in the section spanned by the passage are greater than the corresponding extensions of the passage. If the passage is configured as a cylindrical hole, the depression is preferably arranged concentric to same and the delimitation of the depression has a radius that is larger than the radius of the passage. The depression is preferably configured in such a fashion that a coupling means such as the insertion part with a gripper part does not protrude beyond the section spanned by the external surface of the central element. By virtue of a circumferentially arranged depression, there is a pivotal range of the swivel element on the central element of essentially 360°.

Advantageously, at least in one region of the counter coupling means at least one stop is provided for limiting the swivel range of the swivel element, that is pivotally connected to the central element. Because the connection device according to the invention must frequently be assembled at a great height over the building floor, the occupational safety of the fitting personnel must be carefully considered. If at least one swivel element is joined with the central element, the at least one stop prevents an undesirable rotation away of the swivel element in the central element in the insertion position, in which the swivel element can fall out of the central movement during assembly. After the joining process the installer has his hands free for the other installation work. By means of two or more stops in one region of the counter coupling means, the allowable swivel range for a swivel element connected to the central element is limited in such a fashion that statically undesirable orientations, of the at least two parts of the connection device relative to each other are made impossible.

The swivel element can be affixed in a first assembly stem to the corresponding anchoring means and then brought together to the connection device with the central element. By means of the gripper part, the connection perpendicular to the section, which is tensioned by the anchoring means, is assured in the assembled condition. By means of the pivotal connection between the central element and the swivel element, any number of angular positions of the anchoring means relative to each other can be arranged on one and the same connection devices.

Preferably, the swivel element has a first member, a second member and the two members are connected by a connection segment, wherein the coupling means or the counter coupling means is configured on the first member of the swivel element and the receiving part for the anchoring means is configured on the second member of the swivel element. By means of this configuration of the swivel element, the line of action of the forces existing in the affixed anchoring means can be brought to one common point of the connection device. The distance between the first member and the second member of the at least one swivel element is selected so that sufficient space for accommodation of the anchoring means and the connection device is available.

Advantageously, the receiving part for the anchoring means is configured on the second member as an open slot running from one side of the second member. Accordingly, a connection region of the anchoring means can be inserted into the receiving part and affixed to the swivel element. The effort expended in assembly is thus substantially reduced.

Preferably, the connection segment has an insertion opening for inserting the anchoring means, wherein preferably the insertion opening is in communication with the slot in the second member. Accordingly, a connection region of the anchoring means that is substantially larger than the anchoring means, as is required in the case of anchoring means for high loads, can also be inserted into the receiving part and affixed to swivel element. For partially large connection areas of the anchoring means, the insertion opening can be in part expanded. Accordingly, the effort expending at assembly is reduced also in the case of connection devices for high loads.

The connection device, the central element and the at least one swivel element are advantageously made of metal, whereby the manufacture of the parts from cast metal is preferred. Metal and cast metal make possible economical manufacture of the parts while at the same time assuring long service life thereof. Alternatively, one of the parts or all of the parts can be manufactured out of a suitable plastic, which has the properties required for fitness for use.

Other advantageous embodiments and combinations of features of the invention will become apparent from the following detailed description and the set of patent claims.

### BRIEF DESCRIPTION OF THE DRAWINGS

The drawings show:

FIG. 1 represents a section through a steel structure building having a section suspended from a supporting structure;

FIG. 2 represents a connection device according to the invention in side view;

FIG. 3 represents the connection device in section along the line III-III in FIG. 2;

FIG. 4 represents a first exemplary embodiment of a swivel element according to the invention in longitudinal section along the line IV-IV in FIG. 2;

FIG. 5 represents a variation of the central element according to the invention and represented in FIG. 2 in side view;

FIG. 6 represents a third exemplary embodiment of a central element according to the invention in front view, and

FIG. 7 represents a second exemplary embodiment of a swivel element according to the invention in a partial side view.

In principle, identical parts in the Figures are provided with the same reference numbers.

### DETAILED DESCRIPTION OF THE PREFERRED EMBODIMENT

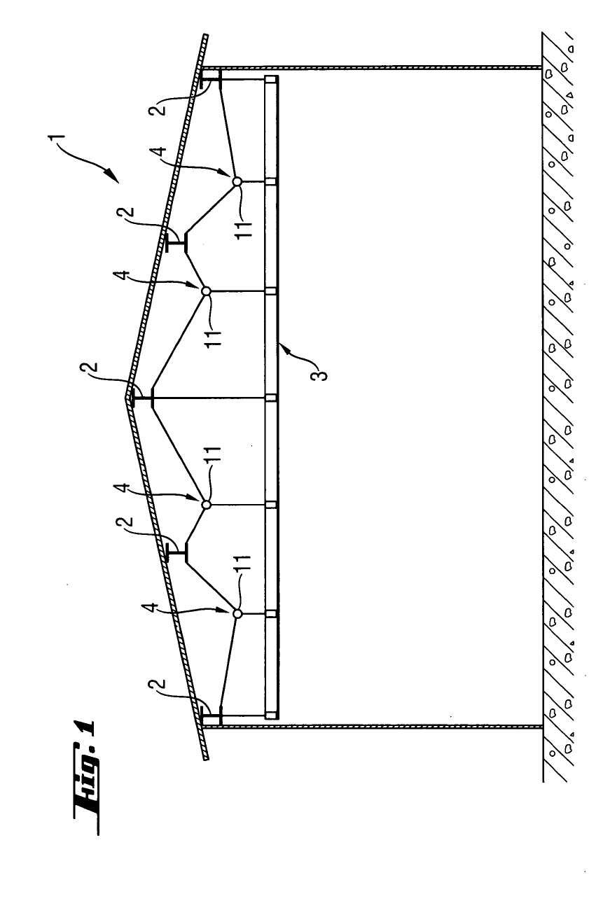

The suspended section 3 is fastened by means of a plurality of suspensions 4 at the supports 2 of the supporting structure of the steel structure building 1 shown in FIG. 1. The individual anchoring means are assembled at different angles by means of connection devices 11 according to the invention.

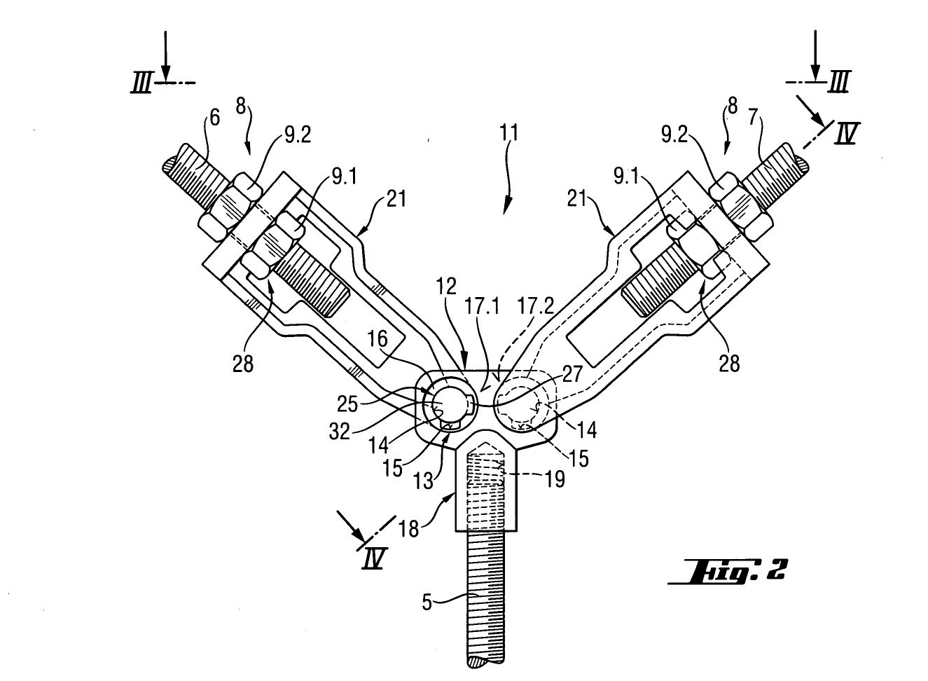

The connection device 11 according to the invention and represented in FIGS. 2 to 4 comprises a central element 12 and two swivel elements 21 pivotally arranged on the central element 12. The central element 12 has as counter coupling means 13, two passageway means 14 forming passages and having opposite spaces end surfaces, and each configured as a cylindrical bore hole, wherein the passages 14 each have a groove 15 running transversely to the plane spanned by the cross-section of the passage 14. The grooves 15 are arranged in such a fashion, that two swivel elements 21 joined with the central element 12 cannot be brought into the insertion position at the same time. In the end surface region of the two passageway means 14, depressions 16 are arranged concentrically to the passage 14. The depressions 16 at both passages 14 are, however, each arranged on the opposing sides 17.1 or 17.2 of the central element 12. The radius of the depressions 16 in the plane of sides 17.1 or 17.2 has a greater magnitude than the radius of the passages 14. A receiving part 18 having a threaded segment 19 configured as an internal thread 19 is provided on the central element 12 for fastening of the first anchoring means 5 in the form of a threaded rod.

The swivel elements 21 (FIG. 4) have a first member 22, a second member 23 and a connection section 24 joining the two members. On the first member 22, the coupling means 25 is configured as a bolt 26 having the gripper part 27 and serving as the insertion part 32 for the coupling means. The receiving part 28, configured as a slot 29, for the anchoring means 6 or 7 is provided on the second member 23. An insertion opening 30 for inserting the anchoring means 6 or 7 having previously arranged nuts 9.1 and 9.2 is in the connecting segment 24. As a factor of the dimensions of the fixation means 8, the insertion opening 30 is segmentally provided with an expansion opening 31. The insertion opening 30 and the slot 29 are in communication with each other. The space 33 available between the first member 22 and the second member 23 is arranged in such fashion, that there is adequate length L for the arrangement of the anchoring means 5, 6 and 7 or the connection device 11. The diagonally arranged anchoring means 6 and 7, configured as threaded rods, have external threads and the nuts 9.1 and 9.2 as the fixation means 8.

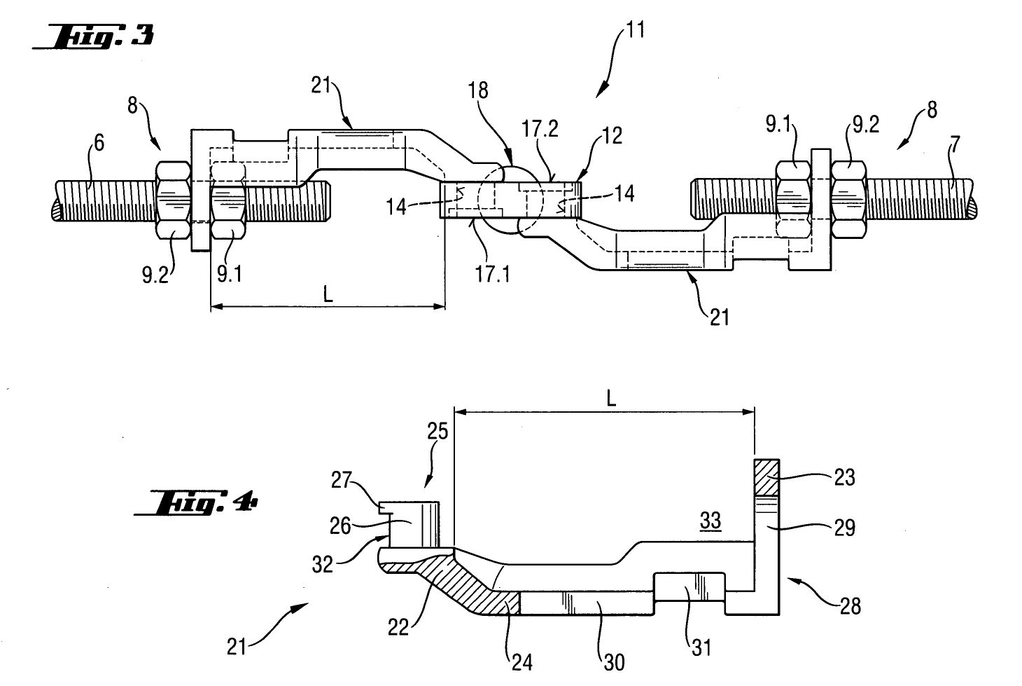

In the following, a possible assembly of a suspension using the connection device 11 according to the invention is described by way of example with reference to FIGS. 2 and 3. The anchoring means 6 and 7 are fastened to the corresponding supports 2 of the steel structure building 1 and joined at the desired location by means of the connection device 11. The central element 12 is connected to the anchoring means 5 using the threaded segment 19. Then one of the swivel elements 21 is inserted into one of the passages 14 of the central element, whereby the groove 15 in the passage 14 forms a guide for the gripper part 27 on the bolt 26 of the swivel element 21. As soon as the gripper part 27 is in a position for gripping the end surface of the passage 14 situated opposite to the direction of insertion, the swivel element 21 is pivoted by rotating about the axis of the bolt 26 on the central element 12 and is secured against unintentional release of the connection. This process is repeated in the case of the second swivel element 21, whereby this second one is inserted in the other passage 14 from the other side 17.1 of the central element 12.

Two nuts 9.1 and 9.2 are arranged at a distance from each other at the connection regions of the anchoring means 6 and 7. The one swivel element 21 is pivoted in the direction of the anchoring means in order to fix the corresponding anchoring means 6 or 7 until the fixation means 8 of the corresponding anchoring means 6 or 7 can be inserted into the receiving part 28 of the corresponding swivel element 21. By rotating the nut 9.1 on the anchoring means 6 and 7 and by adjusting the height by means of the anchoring means 5 and the threaded segment 18, the connection device 11 and consequently the anchoring means 5, 6 and 7 are aligned. By means of the nuts 9.2 serving as counter-nuts, the anchoring means 6 and 7 are removably and adjustably fastened to the swivel elements.

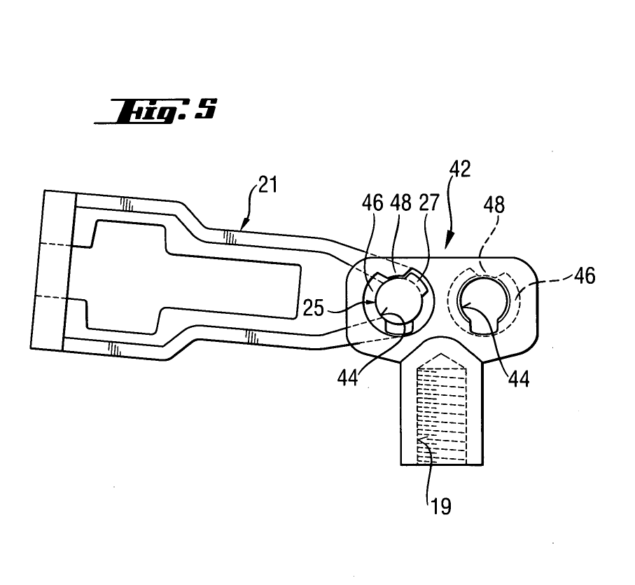

The central element 42 according to the invention represented in FIG. 5 as a variant of the central element 12 represented in FIG. 2 has as the counter coupling means 13 two passages 44 each with a depression 46 at one of the end surfaces, whereby a stop 48 is arranged in each depression 46 for the purpose of limiting the swivel range of a swivel element 21 joined to the central element 42.

In the case of the central element 52 represented in FIG. 6 as a further exemplary embodiment of a central element according to the invention, this one has two coupling means 25. The coupling means each comprise a bolt 56 serving as the insertion part 55, the bolt having a gripper part 57 arranged at the free end of the pin 56. The two coupling means 25 are arranged opposingly on the side walls 53.1 or 53.2. For fixing of the first anchoring means 5, a receiving part 58 having a threaded segment 59 configured as an external thread is arranged on the central element 53.

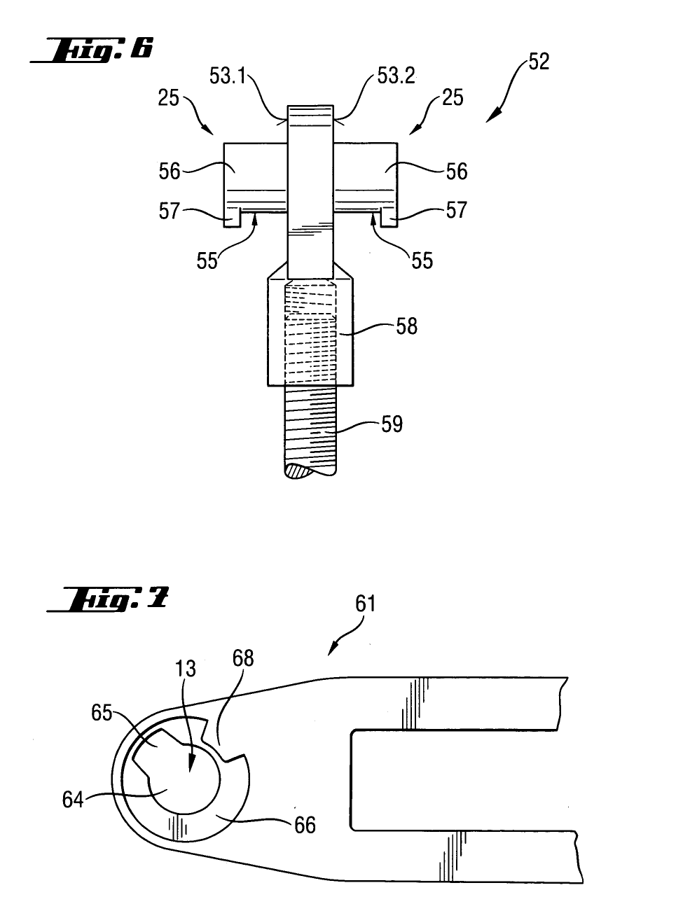

FIG. 7 represents an exemplary embodiment according to the invention of a swivel element 61 having a counter coupling means 13 for arrangement on a central element 52 having at least one coupling means 25. The swivel element 61 has a circular cylindrical passage 64 having a groove running transversely to the plane spanning the cross-section of the passage 64 and a depression 66 having a stop 68 at the outside of the swivel element 61.

1. A connection device for anchoring means 5, 6, 7) of a suspended section (3) suspended on a supporting structure comprises a central element (12; 42; 52) and at least one swivel element (21; 61) pivotally connected to said central element, the connection device (11) has at least one counter coupling means (13) and at least one coupling means (25) insertable into said counter coupling means for providing the pivotal connection between the central element (12; 42; 52) and the at least one swivel element (21; 61), said central element (12; 42; 52) has a receiving part (18; 58) for a first anchoring means (5) and the at least one swivel element (21; 61) has a receiving means (28) for a second anchoring means (6 or 7), the at least one counter coupling means (13) comprising an axially extending passage means (14; 44; 64) for forming a passage (14; 44; 64) having two spaced apart end surfaces extending transversely of the axis and the at least one coupling means (25) comprise an insertion part (27; 57) for gripping one of the end surfaces of said passage means (14; 44; 64).

2. A connection device, as set forth in claim 1, wherein said at least one counter coupling means (13) comprises said axially extending circular cylindrical passage in said passageway means (14; 44; 64) and the at least one coupling means (25) comprises a bolt (26; 52) as said insertion part, said passage means (14; 44; 64) has a groove (15; 65) extending in the axial direction of said passage and said gripper part (27; 59) and formed on an outer circumferential surface thereof substantially complementary to said groove (15; 65).

3. A connection device, as set forth in claim 2, wherein said bolt has a circular cylindrical shape.

4. A connection device, as set forth in claim 2 wherein at least one of the end surfaces of said passage means (14; 44; 64) has a depression (16; 46;66) with an extension structure in the plane of said passage larger than the extension of the passage (14; 46; 64).

5. A connection device, as set forth in claim 1, wherein at least in one region of the counter coupling means (13) at least one stop (28; 68) limits the pivotal range of the at least one swivel element (21; 61) connectable to the control element (42; 52).

6. A connection device, as set forth in claim 1, wherein two said counter coupling means (13) are provided in said control elements and each receive a separate said coupling means (25).

7. A connection device, as set forth in claim 1, wherein the at least one counter coupling means (13) is provided on the central element (12; 42) and the coupling means (25) is provided on the at least one swivel element (21).

8. A connection device, as set forth in claim 1, wherein the at least one coupling means (25) is located on the central element (52) and the counter coupling means (13) is provided on the at least one swivel element (61).

9. A connection device, as set forth in claim 1, wherein said receiving means (8) comprises a threaded segment (19; 59) for connecting the first anchoring means (5) to the central element (12; 52).

10. A connection device, as set forth in claim 1, wherein the at least one swivel element (21; 61) has a first member (22), a second member (23) and a connecting section (24) connecting the first and second members (22; 23), one of the coupling means and the counter coupling means are formed on the first member (21) of the swivel element (21, 61) and the receiving part (28) for said other anchoring means (6 or 7) is formed on said second member (23) of the at least one swivel element (21; 61).

11. A connection device, as set forth in claim 10, wherein the receiving means (28) for the anchoring means (6 or 7) on the second member (23) of the at least one swivel element (21; 61) is shaped as an open slot (29) running from one side of the second member.

12. A connection device, as set forth in claim 10, wherein the connecting segment (24) of the at least one swivel element (21; 61) has an insertion opening (30) for inserting the anchoring means (6 or 7).

13. A connection device, as set forth in claim 12, wherein the insertion opening is in communication with the slot (29) in the second member (23) of the at least one swivel element (21; 61).
